(19) United States
(12) Patent Application Publication
(10) Pub. No.: US 2005/0052279 A1
(43) Pub. Date: Mar. 10, 2005

(54) RFID system with selectable backscatter parameters

(76) Inventor: Raj Bridgelall, Morgan Hill, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/927,775

(22) Filed: Aug. 27, 2004

Related U.S. Application Data
(60) Provisional application No. 60/498,843, filed on Aug. 29, 2003.

(51) Int. Cl. H04Q 5/22

(52) U.S. Cl. 340/10.1

(57) ABSTRACT

A RFID tag for use in an RFID system is disclosed. The RFID tag comprises an antenna operable to receive a carrier wave from an RFID reader. A state machine is coupled to the antenna and receives a backscattering command comprising a backscattering parameter for the RFID tag to use for backscattering the carrier wave. A modulator is coupled between the antenna and the state machine. The modulator produces a modulated backscatter signal, based at least partially dependent on the backscattering command.

### CROSS REFERENCE TO RELATED APPLICATIONS

This application claims priority to U.S. Provisional application 60/498,843 filed on Aug. 29, 2003.

### TECHNICAL FIELD

This invention relates to the field of radio frequency identification and, more specifically to a RFID system with selectable backscatter parameters.

### BACKGROUND

In today's highly competitive marketplace, the ability to manage and track inventory is vitally important. A major cost to consumer retail stores and other businesses that handle a large inventory is the cost of tracking individual items of the inventory as those items move throughout the supply chain.

Traditionally, barcodes and barcode scanners have been used to track inventory. Barcode scanning systems work by labeling items with a barcode that encodes a product identification number. When needed, the barcode is read using a barcode reader. While this system is useful for some applications, barcodes have several drawbacks. First, barcodes are limited in the amount of information that can be encoded. Also, once a barcode is printed, it is impossible to change the barcode and thus it is impossible to change the encoded information. Additionally, a barcode must be in the line of sight of the barcode reader to be read.

To alleviate some of the drawbacks of barcode systems, various Radio Frequency Identification (RFID) systems have been proposed. In a typical asset-tracking embodiment, a RFID system comprises at least one RFID reader and at least one RFID tag. RFID tags are place upon the asset to be tracked. RFID tags typically fall into one of two types; active RFID tags, which include an on-board power source (such as a battery) or passive RFID tags, which are powered by a radio frequency carrier wave sent from the RFID reader. Active RFID tags typically can be read by a RFID reader at a longer range than passive RFID tags, which typically must be near the tag reader in order to receive the carrier wave from the RFID reader to power the RFID tag

Passive RFID tags typically store data in a non-volatile memory. To read the stored data, a RFID reader emits a time varying radio frequency carrier wave, which powers the passive RFID tag by the generation of an AC voltage across the antenna of the passive tag. The AC voltage is typically rectified to a DC voltage. The DC voltage builds until the DC voltage reaches a minimum operating DC voltage, activating the RFID tag. Once activated, the RFID tag can send data stored in the RFID tag memory. This is typically done by modulated backscattering of the carrier wave received from the RFID reader. The RFID tag backscatters by causing changes in the amplitude and/or phase of the RFID reader's carrier frequency. The RFID tag performs the modulation of the RF carrier wave by altering the load impedance of the RFID tag's antenna 210.

RFID systems typically utilize frequencies that are within one of several frequency ranges including the low frequency range, 125 KHz, the high frequency range 13.56 MHz and the ultra high frequency range of 800-900 MHz and 2.45 GHz (microwave). These are only examples of usable frequency ranges. The exact frequency ranges that can be used for an RFID system can vary by country. The assigned frequency range is often channelized (split into multiple channels) in order to allow multiple RFID readers to be operated at the same time. Having channels close together create the possibility that an RFID reader in close proximity to the RFID tag can overpower the backscatter modulation from the RFID tag. In many cases, the local regulatory committees predetermine the channel spacing and using tags with a fixed backscatter modulation rate may result in modulation sidebands close to the carrier frequencies of the adjacent channel. One element of interference results from the phase noise of the reader oscillator falling in the same frequency range of the tag's backscatter modulation sideband.

Additionally, at times the frequency that the RFID tags is designed to backscatter at is noisy and/or crowded. This can result in a weak signal being backscattered back to the RFID reader, which can reduce the range of the system as well as result in the potential loss of data. RFID tags are unable to avoid such frequency interference because RFID tags are unable to switch the frequency that the RFID tag backscatter modulates the RFID reader's carrier wave, resulting in poor reception between the RFID tag and the RFID reader.

Therefore, there is a need to provide RFID tags that can alter backscatter parameters, upon receiving a particular command. In one embodiment, the backscatter parameter is the frequency at which the RFID tag backscatter modulates the carrier wave. Backscatter parameters can also include the modulating scheme and the data rate of the RFID tag.

### BRIEF SUMMARY

In one embodiment of the present invention, a RFID tag for use in an RFID system is disclosed. The RFID tag comprises an antenna operable to receive a carrier wave from an RFID reader. A state machine is coupled to the antenna and receives a backscattering command comprising a backscattering parameter for the RFID tag to use for backscattering the carrier wave. A modulator is coupled between the antenna and the state machine. The modulator produces a modulated backscatter signal, based at least partially dependent on the backscattering command.

In one aspect of the present invention, the backscattering command determines the frequency of the backscatter signal. In another aspect of the present invention, the backscattering command determines the modulation scheme of the backscatter signal. In another aspect of the present invention, a non-volatile memory that stores a code related to a product.

In another embodiment of the present invention, a method for operating an RFID tag is disclosed. In a first step, a backscatter modulation signal setting based on a command received from an RFID reader is determined. Next, a backscatter modulation signal based at least partially on the backscatter signal setting is generated. In one aspect of the present invention the backscatter modulation signal setting sets the state of a state machine such that the backscatter modulation signal is set to a specific frequency. In another aspect of the present invention, backscatter modulation signal setting sets the state of a state machine such that modulation scheme is set.

### BRIEF DESCRIPTION OF THE DRAWINGS

The present invention will hereinafter be described in conjunction with the following drawing figures, wherein like numerals denote like elements, and:

FIG. 1 is a block diagram of an RFID system in accordance with the teachings of the present invention;

FIG. 2 is a block diagram of a RFID reader and RFID tag in accordance with the teachings of the present invention; and

FIG. 3 is a flow chart illustrating a method of changing backscatter parameters in accordance with the teachings of the present invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. While passive RFID tags are discussed below, this is for exemplary purposes only and the present invention can utilize passive, semi-passive or active RFID tags.

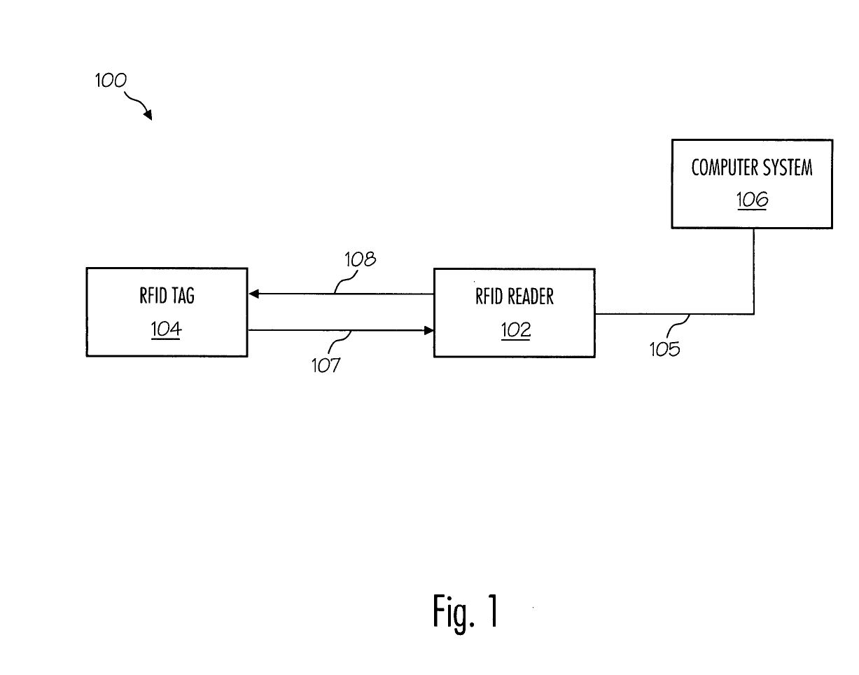

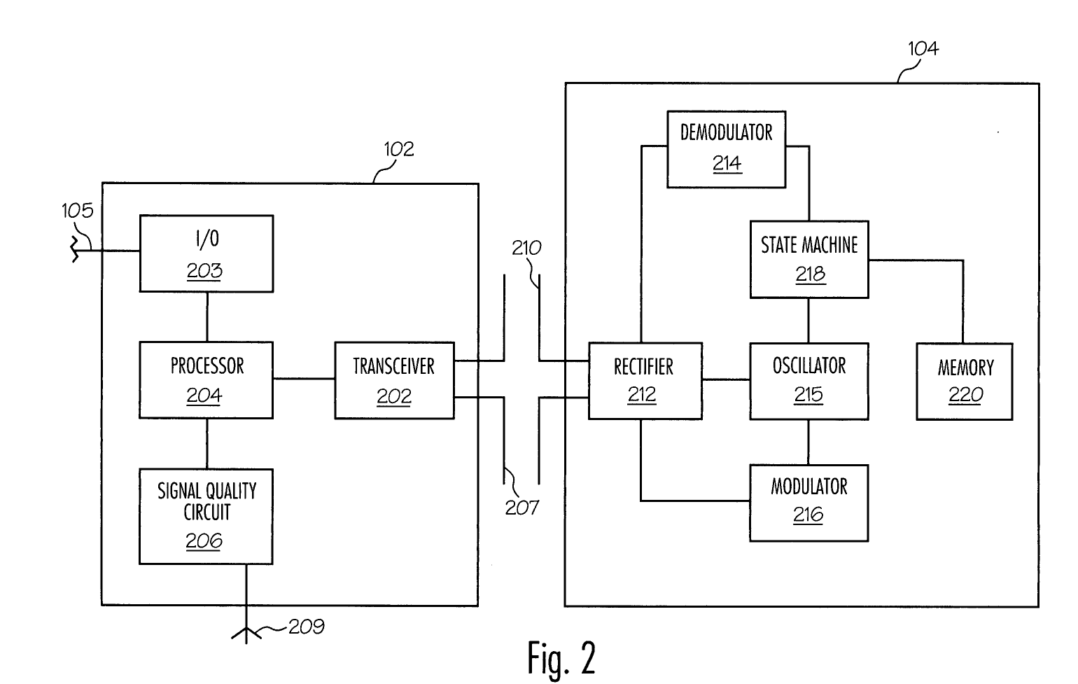

FIGS. 1-2 illustrate an RFID system 100 in accordance with the teachings of the present invention. RFID system 100, in one embodiment, comprises an RFID reader 102 coupled to at least one RFID tag 104. RFID system 100 may also optionally include a computer system 106 coupled to the RFID reader 102. In one embodiment of the present invention, RFID reader 102 can determine the quality of the frequency spectrum used by the RFID system 100 and can send an interrogation signal 107 including a command to the RFID tag 104 indicative of a frequency or frequencies at which the RFID tag 104 should backscatter a modulated backscatter signal 108. Note that changing the frequency at which the RFID tag 104 backscatter modulates the carrier wave may change the data rate of the RFID tag.

In one embodiment, RFID reader 102 comprises a transceiver 202 coupled to a processor 204 and a signal quality indicator circuit 206. Transceiver 202 couples to a RFID reader antenna 207. The signal quality indicator circuit 206 couples to a signal strength antenna 209.

Signal quality indicator circuit 206 can be any device that can determine can scan a frequency range used by the RFID system 100 to determine the quality of individual frequency channels within the frequency range. In one embodiment, an entire frequency range can be scanned. In another embodiment, only a predetermined subset of frequencies in a frequency range corresponding to frequencies that could be used by the RFID tag 104 are checked to determine signal quality. For example, the signal to noise ratio for each frequency can be checked. Signal to noise ratio measurements, as well as other signal quality measurements are known in the art and various signal strength measurement techniques can be used in the present invention. Signal quality indicator circuit 206 can utilize the signal strength antenna 209 or, alternatively can be coupled to the RFID reader antenna 207, eliminating the need for the signal quality indicator circuit 206 and the signal strength antenna 209. In an alternative embodiment, RFID transceiver 202 can be used to determine the quality of individual frequency channels, within the frequency range.

In one embodiment, processor 204 receives signal quality measurements from signal strength indicator circuit 206 or, alternatively, from transceiver 202. Processor 204 analyzes the signal quality measurements for the frequencies within the range and determines the frequency or frequencies that should be used by RFID tag 104 for backscattering. Also, in one embodiment, the processor 204 can determine a frequency at which the RFID tag 104 should backscatter modulate the carrier wave based on a desired data rate. Processor 204 additionally can provide transceiver 202 with proper commands to transmit to RFID tag 104. Processor 204 can be any processor, such as those processors conventionally used in RFID readers or other similar applications.

Transceiver 202 can be any device capable of transmitting signals, including transmitting a carrier wave signal to RFID tag 104, and capable of receiving signals, including the backscattered signals from the RFID tag 104. Transceiver 202 includes any necessary circuitry needed to send and receive data such as any needed modulation/demodulation circuitry and any encoding/decoding circuitry.

Output 203 can be any output device used by the RFID reader to display, store and/or transmit data retrieved from or derived from data retrieved from RFID tag 104. This can include a RFID reader display, a memory, a wireless transceiver in communication with a wireless local area network and the like. For example output 203 can connect to a computer system 106 via connection 105 to output 203. In this embodiment, connection 105 can be a wired or wireless connection.

In one embodiment of the present invention, RFID tag 104 includes an antenna 210 coupled to a voltage rectifier 212 coupled to a demodulator 214, and a modulator 216. The demodulator 214 is coupled to a state machine 218, which is coupled to a memory 220. Modulator 216 couples to the state machine 218, the memory 220 and, optionally, an oscillator 215.

Antenna 210, in one embodiment, can be a coil antenna, a dipole antenna or any antenna designed such that an RF transmission, such as a carrier wave sent by the RFID reader 102, will induce an AC voltage. The design of the antenna 210 can depend on the application of the RFID tag 104 and the frequency in which the RFID tag 104 operates.

Voltage rectifier 212, in one embodiment, converts the induced AC voltage to a useable DC voltage. The DC voltage powers the operation of the RFID tag 104. As the antenna 210 is exposed to the carrier wave from the RFID reader 102, the induced AC voltage will be converted to a DC voltage when rectified by voltage rectifier 212. The DC voltage will increase until a critical voltage is reached, activating the RFID tag 104.

Demodulator 214 demodulates any incoming modulated signals received from RFID reader 102. While the initial RF carrier wave from the RFID reader 102 is designed to activate and power RFID tag 104, as discussed previously, modulated data can also be sent by the RFID reader 102, such as data used to set the state of the RFID tag 104.

State machine 218 can be any device capable of setting the state of the RFID tag 104 upon receipt of a proper request or command from the RFID reader 102. States of the RFID tag may include a read state, a write state, a calibration state and a command state. In the present invention, different states can also exist for different frequency settings at which to backscatter modulate the carrier wave. Additionally, states can exist corresponding to changes in other parameters that effect backscattering of the carrier wave, such as the modulation scheme.

In one embodiment of the present invention, the RFID tag 104 can receive commands from the RFID reader 102. In one embodiment, there can be multiple states with each different state representing one or more frequencies to be used by the RFID tag 104 to backscatter the RFID reader's 102 carrier wave. A command sent by the RFID reader 102 can set the RFID tag 104 into one of the states, with the state selected representing the frequency determined by the RFID reader 102 as the frequency the RFID tag 104 should use for backscatter modulation. Alternative, one or more states can represent a change in another backscattering parameter, such as different states representing different modulation schemes. A command can be received by the RFID tag 104 that selects one of these states. Also, the data rate can also be set by changing the state of state machine 218. The designs of state machines for use in RFID tags 104 are well known in the art. For example, state machines may be implemented using logic circuits such as programmable logic devices. In an embodiment of the present invention, state machine 218 can be a processor that can implement the functions of a state machine or behave in a similar manner. For example, the state machine could be implemented as software running on the processor.

Memory 220 stores data, including, depending on the use of RFID tag 104, a product identification number, product description and the like. Memory 220 is preferably a non-volatile memory. Depending on the application, memory 220 can be a read-only memory or a read/write memory. In one embodiment, a product identification code stored in memory 220 can be retrieved from the memory 220 and presented to the modulator for transmission to the RFID reader 102.

Oscillator 215 provides a clocking signal to RFID tag 104. Oscillator 215 can be set to a certain frequency, which can be then be down divided into other frequencies using a frequency divider circuit. The frequency set by the oscillator 215 can be used to set the frequency of the modulation of the carrier wave. In an alternative embodiment of the present invention, the carrier wave from the RFID reader 102 can be used to adjust the accuracy of the oscillator 215. In yet another alternative embodiment, RFID tag 104 does not use oscillator 215 and all timing information can be extracted from the carrier wave of the RFID reader 102.

Modulator 216 modulates the carrier wave sent by the RFID reader 102 to send the data to RFID reader 102. Modulator 216 can employ a variety of modulation means such as frequency shift key (FSK), phase shift key (PSK) and amplitude shift key (ASK). The carrier wave from the RFID reader 102 is modulated and backscattered to the RFID reader 102. In one embodiment of the present invention, the type of modulation is one of the backscattering characteristics that can be changed for the RFID tag 104.

As discussed previously, in a typical embodiment, the RFID tag 104 backscatters by load modulation, that is, by changing the load impedance of the RFID tag antenna. Typically, load modulation is implemented by changing the load impedance on the RFID tag's antenna 210. One way to do this is to switch a resistive load on and off in time with the transmitting of the data stream. A capacitor can be used in place of the resistor. The rate at which the load impedance changes (cycling the resistive or capacitive element on and off) determines the frequency at which the backscatter occurs. The rate of the change of the load impedance of the RFID tag's antenna 210 is controlled by the output of the oscillator 215 or some other timing signal. For example, in one embodiment, depending on the state set by state machine 218, the modulator 216 can select one of several rates at which the load impedance off of the RFID tag 104 is changing, shifting the backscatter modulated signal from one frequency to a second frequency.

For example, for FSK modulation, the logical ones and zeroes are sent at separate frequencies. In one embodiment, a logical one can be backscattered at the oscillator's base frequency divided by eight (or one-eight of the oscillator's base frequency) and a logical zero backscattered at the oscillator's base frequency divide by ten (or one tenth of the oscillator's base frequency). By altering the output of the oscillator 215, different sets of frequencies can be selected to modulate the ones and zeroes.

Optional computer system 106 can be any computer that can receive data from RFID reader 102 and that can perform some action on that data. In an environment where the RFID system 100 is a point of sale system, once the RFID reader 102 receives the requested product code from the RFID tag 104 affixed to a product that information can be sent to computer system 106. Computer system 106 can perform a price lookup and generate an entry into a sales receipt. In an inventory control system, information gathered by the RFID reader 102 can be sent to the computer system 106 running inventory tracking software. The various useful computer systems and the software needed to run them are known in the art.

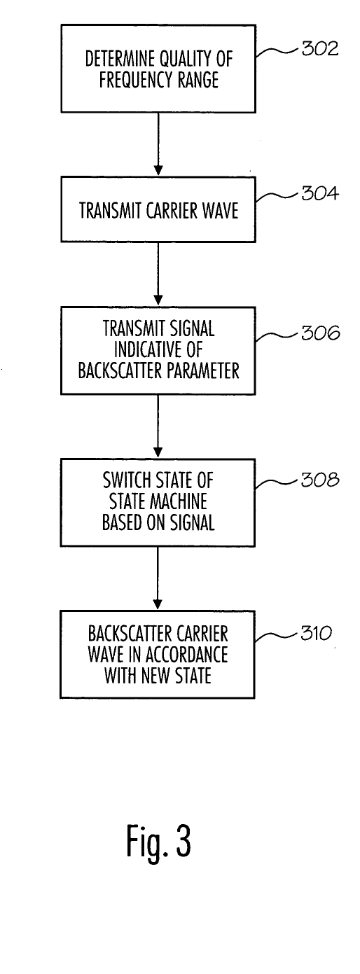

FIG. 3 is a flowchart of a method of changing backscattering parameters in accordance with the teachings of the present invention. In a first step, step 302, RFID reader 102 scans the frequency spectrum to determine the optimal frequency for the RFID tag to use when backscattering. The selection of the optimal frequency to use for backscattering can be based on the signal quality of the various frequencies measured, in one embodiment, by the signal to noise ratio of each of the frequencies. In another embodiment, the frequency at which to have the RFID tag 104 backscatter the carrier wave can be based on a desired data rate. In some modulation schemes, the data rate and the frequency of the backscatter modulated frequency are elated. Additionally, the choice of an optimal frequency to use can be based, at least partially, on other backscattering parameters, such as the modulation scheme.

Next, in step 304, the RFID reader 102 transmits a carrier wave to power the RFID tag 104. As discussed previously, in a typical embodiment, the carrier wave induces an AC voltage in the antenna which is converted to a DC voltage by voltage rectifier 212. After the DC voltage reaches a sufficient level, the RFID tag 104 is activated.

In step 306, the RFID reader 102 transmits a signal indicative of a backscatter parameter to set. In one embodiment of the present invention, the signal can be used to set the state of state machine 218, the state chosen having one or more backscatter parameters. In one exemplary embodiment, the backscatter parameter can be the frequency that should be used for backscattering. This signal, in one embodiment, can be transmitted as a code along with any other commands or data that is sent to RFID tag 104. In an alternative embodiment, the RFID reader 102 can transmit a signal indicative of another backscatter parameter that is to be altered. For example, the RFID reader 102 transmits a signal to alter the modulation scheme.

Next, in step 308, the command sent by the RFID reader 102 can, in one embodiment, switch the state of the state machine to change a backscatter parameter. For example, there can be multiple states, with each state comprising a different backscatter frequency.

Then, in step 310, the RFID tag 104 replies to the RFID reader 102 via backscattering the carrier wave of the RFID reader 102. In the present invention, the backscattering will be accomplished using, at least in part, the backscattering parameters sent by the RFID reader 102. For example, the backscatter can occur at the frequency set by the RFID reader 102. This can be done by varying the impedance of the RFID antenna at a rate controlled by the oscillator 215 that will produce the necessary frequency as determined by the RFID reader 102. In another embodiment, the backscattering can be modulated using a modulation scheme as set by the RFID reader 102.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A RFID tag comprising:
an antenna operable to receive a carrier wave from an RFID reader;
a state machine coupled to the antenna, the state machine operable to receive a backscattering command comprising a backscattering parameter for the RFID tag to use for backscattering the carrier wave; and
a modulator coupled between the antenna and the state machine, the modulator operable to produce a modulated backscatter signal, at least partially formed based on the backscattering parameters.

2. The RFID tag of claim 1 wherein the backscattering command determines the frequency of the modulated backscatter signal.

3. The RFID tag of claim 1 wherein the backscattering command determines the modulation scheme of the modulated backscatter signal.

4. The RFID tag of claim 1 further comprising a non-volatile memory that stores a code related to a product.

5. The RFID tag of claim 4 wherein the memory is a read/write memory.

6. The RFID tag of claim 1 wherein the antenna is operable to receive a frequency in the ultra high frequency range.

7. The RFID tag of claim 1 further comprising a voltage rectifier operable to convert an induced AC voltage induced by the carrier wave to a DC voltage.

8. The RFID tag of claim 1 further comprising an oscillator, the frequency of the oscillator determining the frequency of the modulated backscatter signal.

9. The RFID tag of claim 8 wherein a frequency outputted by the oscillator is determined by the state of the state machine as set by the backscattering command.

10. The RFID tag of claim 9 wherein a timing signal sent with the carrier wave is used to determine the frequency of the modulated backscattered signal.

11. The RFID tag of claim 10 wherein the frequency produced by the timing signal is determined by the state of the state machine as set by the backscattering command.

12. A RFID reader for use in an RFID system comprising:
signal strength quality indicator means for determining a signal strength of one or more frequencies in a range of frequencies;
processor means for generating a command based on the output of the signal strength circuit; and
transceiver means for generating a signal containing the command.

13. The RFID reader of claim 12 wherein the command determines a frequency an RFID tag should use for a backscatter signal.

14. The RFID reader of claim 12 wherein the command determines a modulation scheme an RFID tag should use for a backscatter signal.

15. The RFID reader of claim 12 wherein the RFID reader is coupled to a point of sales system.

16. A method for operating an RFID tag comprising:
determining a backscatter modulation signal setting based on a command received from an RFID reader; and
generating a backscatter modulation signal based at least partially on the backscatter modulation signal setting.

17. The method of claim 16 wherein the step of determining a backscatter signal setting based on a command received from an RFID reader further comprises setting a state of a state machine such that the backscatter modulation signal is set to a specific frequency.

18. The method of claim 16 wherein the step of determining a backscatter signal setting based on a command received from an RFID reader further comprises setting a state of a state machine such that a selected modulation scheme is used to modulate the backscatter modulation signal.

19. The method of claim 16 further comprising the steps of:
inducing an AC voltage from a received carrier wave;
rectifying the AC voltage to produce a DC voltage; and
powering the RFID tag at least partly with the DC voltage.

20. The method of claim 16 further comprising sending a product identification number in the backscatter modulation signal.
